(19) United States
(12) Patent Application Publication
(10) Pub. No.: US 2023/0092697 A1
(43) Pub. Date: Mar. 23, 2023

(54) METAL TRACES

(71) Applicant: Hewlett-Packard Development Company, L.P., Fort Collins, CO (US)

(72) Inventors: Anthony Donald Studer, Albany, OR (US); David Olsen, Corvallis, OR (US); Paul David Schweitzer, Corvallis, OR (US)

(21) Appl. No.: 16/958,107

(22) PCT Filed: Dec. 2, 2019
(86) PCT No.: PCT/US2019/063966

§ 371 Date: Jun. 25, 2020

(51) Int. Cl. B41J 2/175

(52) U.S. Cl. CPC B41J 2/17553

(57) ABSTRACT

Examples of metal traces are described herein. In some examples, a print cartridge includes metal traces. Some examples of a print cartridge may include a joint. In some examples, the joint may be a laser-welded joint. In some examples of the print cartridge, the print cartridge may also include metal traces situated in the laser-welded joint.

### BACKGROUND

Some types of printing utilize liquid. For example, some types of printing extrude liquid onto media or material to produce a printed product (e.g., two-dimensional (2D) printed content, three-dimensional (3D) printed objects). In some examples, a print head may be utilized to extrude ink onto paper to print text and/or images. In some examples, a print head may be utilized to extrude fusing agent onto powder in order to form a 3D printed object.

### BRIEF DESCRIPTION OF THE DRAWINGS

FIG. 1 is a diagram illustrating a perspective view of an example of a print cartridge;

FIG. 2A is a diagram illustrating an example of an electrical connector;

FIG. 2B is a diagram illustrating an example of a magnified view of metal traces;

FIG. 3A is a diagram illustrating an example of a body;

FIG. 3B illustrates an enlarged view of an example of a portion of the body;

FIG. 3C illustrates an example of a lid;

FIG. 3D illustrates an enlarged view of an example of a portion of the lid;

FIG. 4A is a diagram illustrating an example of a print liquid supply unit;

FIG. 4B illustrates an example of a cross section of the print liquid supply unit before welding;

FIG. 4C illustrates an example of the cross section of the print liquid supply unit after welding;

FIG. 5A is a diagram illustrating an enlarged view of an example of a passage region;

FIG. 5B is a diagram illustrating an enlarged view of an example of a passage region;

FIG. 6A is a diagram illustrating a side view of an example of a metal trace or metal traces and protective layers;

FIG. 6B is a diagram illustrating a side view of an example of an metal trace or metal traces and protective layers;

FIG. 6C is a diagram illustrating a front view of an example of flexible electrical connector including metal traces and protective layers;

FIG. 7 is a flow diagram illustrating one example of a method for manufacturing a print cartridge;

FIG. 8 shows an example print cartridge;

FIG. 9 is a cross-sectional view through the line C-C of the example print cartridge of FIG. 8;

FIG. 10 shows another example print cartridge;

FIGS. 11A and 11B are perspective views of another example print cartridge;

FIG. 12 is a magnified view of part of the example cartridge; and

FIG. 13 is a perspective view of an example of a laser-welded joint of a print cartridge.

### DETAILED DESCRIPTION

Some issues arise in the context of utilizing print liquid. Print liquid is a fluid for printing. Examples of print liquid include ink and fusing agent. In some examples, accurately sensing an amount of print liquid remaining in a reservoir may be difficult due to issues like liquid bridging, environmental conditions, and water vapor transmission rates. An inaccurately sensed liquid level may lead to changing the reservoir more often, wasting print liquid, and/or increasing printing expense. Accordingly, it may be beneficial to provide more delivered print liquid, a more reliable sensed print liquid level, and/or less print liquid supply changes.

A sensor or sensors may be utilized to increase print liquid level sensing accuracy. The sensor(s) may be housed in a print cartridge. A print cartridge is a container that holds print liquid. In some examples, a print cartridge may be referred to as a print liquid supply unit, print liquid container, a cartridge, a supply, print liquid supply cartridge, etc. The print liquid may be supplied to a printer. In some examples, four print liquid supplies may be utilized for a printer, which may include black, cyan, magenta, and yellow print liquid supplies. This may allow print liquid supplies with colors to be replaced individually. For example, a print liquid color that is used more often may be replaced individually without replacing remaining print liquid of another color or colors.

In some examples, print cartridges may be constructed of thermoplastics. Thermoplastics may be injection molded and may be compatible with high volume manufacturing and/or assembly methods. It may be beneficial for the construction materials (e.g., materials to construct components of the print liquid supply) to be compatible with the print liquid, to be robust to environmental conditions during shipping/handling, and/or to provide target water vapor transmission rates such that print quality is maintained over the life of the print cartridge. In some examples, print cartridges may be constructed from thermoplastics such as polypropylene (PP), low-density polyethylene (LDPE), high-density polyethylene (HDPE), polyethylene terephthalate (PET), polycarbonate (PC), and/or blends thereof (e.g., copolymers such as a polypropylene-polyethylene blend). Some thermoplastics may be compatible with high volume assembly methods such as ultrasonic welding, vibration welding, and/or laser welding. In some examples, welding (e.g., laser welding) may be capable of creating waterproof joint seals to contain the print liquid. As used herein, “welding,” “weld,” and variations thereof may denote laser welding, ultrasonic welding, and/or vibration welding. Other approaches for joining components may be excluded from the term “welding” (and variations thereof) in some examples.

Welding may be beneficial because plastic parts may be joined via high speed melting. For example, welding may not include utilizing another bonding agent or additional parts. Issues may arise when attempting to pass an electrical connection through a welded joint. For example, a sensor may be housed in a print cartridge and may utilize a conductor that passes through a welded joint. Some examples of the techniques described herein may include providing an electrical connection through a joint that is welded.

In some examples, the electrical connection may be sealed through a joint of thermoplastic material without other materials. Some examples may not utilize double-sided pressure sensitive adhesive (PSA) gaskets, elastomeric gaskets, and/or various glue joints, which may increase a number of constraints such as compatibility with print liquid, ability to seal different joint materials and the electrical connection, robustness, and/or setting/curing time. Some examples may provide a flexible electrical connection that can be placed in the joint and sealed via local compression by laser welding the joint.

Throughout the drawings, identical reference numbers may designate similar, but not necessarily identical, elements. Similar numbers may indicate similar elements. When an element is referred to without a reference number, this may refer to the element generally, without necessary limitation to any particular Figure. The figures are not necessarily to scale, and the size of some parts may be exaggerated to more clearly illustrate the example shown. Moreover, the drawings provide examples and/or implementations in accordance with the description; however, the description is not limited to the examples and/or implementations provided in the drawings.

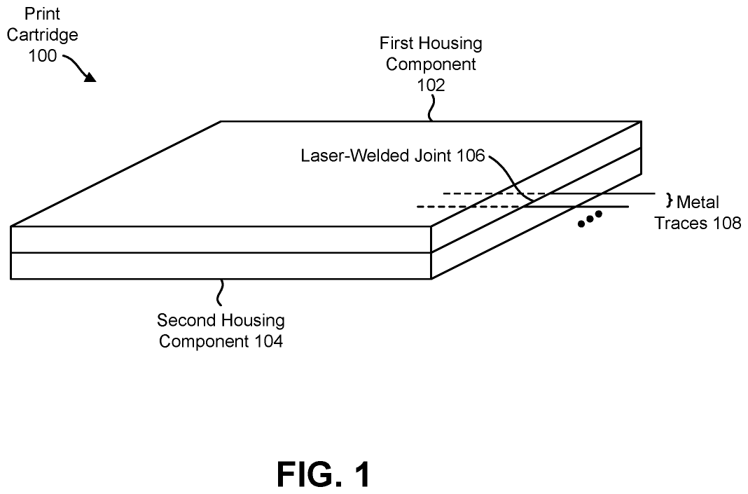

FIG. 1 is a diagram illustrating a perspective view of an example of a print cartridge 100. Examples of the print cartridge 100 include print liquid supply units, print liquid containers, cartridges, supplies, print liquid supply cartridges, etc. The print cartridge 100 may contain and/or transfer print liquid (e.g., ink, agent, etc.). In some examples, the print cartridge 100 may be designed to interface with a host device. A host device is a device that uses and/or applies print liquid. Examples of a host device include printers, ink jet printers, 3D printers, print heads, etc. For example, it may be beneficial to replenish or replace the print cartridge 100 when some or all of the print liquid has been utilized.

In the example illustrated in FIG. 1, the print cartridge 100 includes a first housing component 102 and a second housing component 104. The first housing component 102 and the second housing component 104 are structures for containing print liquid. For example, the first housing component 102 may be joined to the second housing component 104 to form a volume to contain print liquid. In some examples, the first housing component 102 and the second housing component 104 may be made of a thermoplastic or a combination of thermoplastics. In some examples, the first housing component 102 may be a lid of the print cartridge 100 and the second housing component may be body of the print cartridge 100.

The first housing component 102 may be welded to the second housing component 104 along a laser-welded joint 106. The laser-welded joint 106 is an interface between the first housing component 102 and the second housing component 104. In some examples, the laser-welded joint 106 is welded to join housing components of the print cartridge 100. For instance, the first housing component 102 may be welded to the second housing component 104 along the laser-welded joint 106 using laser welding, ultrasonic welding, and/or vibration welding. In some examples, welding may be applied along the entire laser-welded joint 106. In other examples, welding may be applied along a portion (e.g., not the entire path) of the laser-welded joint 106. The first housing component 102 may include first joint geometry and the second housing component 104 may include second joint geometry. Joint geometry is a form or shape of a surface along which the laser-welded joint 106 may be formed.

Welding may cause a phase change (e.g., melt) in the material of the first housing component 102 and/or the second housing component 104. For example, the second housing component 104 may have an opening on one side of the second housing component to be closed with the first housing component to make a waterproof seal for the print liquid. In some examples, the first housing component 102 and the second housing component 104 may be made of polypropylene material and may be joined using laser welding. In some examples, the laser-welded joint 106 may be between opposite housing components including the first housing component 102 and the second housing component 104. In some examples, the first housing component 102 and the second housing component 104 have an overlapping melting temperature range. For instance, a laser may apply energy to the second housing component 104 and/or the first housing component 102. Heat generated by the laser may cause both the second housing component 104 and the first housing component 102 to melt at a same temperature in some approaches.

Some examples of melting temperatures of materials that may be utilized for the print cartridge (e.g., the first housing component 102 and/or the second housing component 104) are given as follows. Polypropylene may have a minimum melting temperature of approximately 160 degrees Celsius (C). With a blended copolymer (e.g., polypropylene with polyethene), minimum melting temperatures may be within a range between approximately 130 C and 160 C depending on the blend.

In some cases, some materials may become damaged if applied heat is too high for an amount of time. Applying high heat (e.g., 300 C) to some materials (e.g., plastics) for an amount of time may damage the materials. In some approaches to laser welding, where time at temperature may be relatively short, the materials (e.g., polymers, depending on the blend) may withstand higher temperatures without becoming too damaged. In some examples, maximum laser welding temperatures may range from approximately 300 C to 350 C, above which damage may occur.

In some examples, at least a portion of the first housing component 102 (near the laser-welded joint 106, for instance) of the print cartridge 100 may be at least partly laser transmissive or at least partly transparent. In some examples, at least a portion of the second housing component 104 may be at least partly laser absorptive or at least partly opaque. In some examples, at least a portion of the second housing component 104 may be at least partly laser-transmissive (near the laser-welded joint 106, for instance) or transparent and at least a portion of the first housing component 102 may be at least partly laser-absorptive.

In some examples, at least a portion of the print cartridge 100 is designed (e.g., optimized) to melt using a welding laser. For instance, joint material in a weld path may be designed to melt when a welding laser is applied. In some examples, a welding laser (e.g., near infrared (IR) laser) may have a wavelength of approximately 980 nanometers (nm) (e.g., in a 900-1080 nm range). A housing component (e.g., the first housing component 102) may have a transmissivity in a range (e.g., a 30-60% range) and another housing component (e.g., the second housing component 104) may be doped such that the housing component is absorptive (e.g., 90%-100% absorptive). In some examples, a housing component (e.g., the first housing component 102) may heat up, while a majority of molten material used to form the weld may come from the other housing component (e.g., the second housing component 104).

In some examples, the first housing component 102 may be press-fit to the second housing component 104 via a post or posts that serve to align the first housing component 102 and keep it on the second housing component 104 as the print cartridge 100 enters a welder. Pressure may be applied to the print cartridge 100. For example, a clamp may be applied to the first housing component 102 while the second housing component 104 is supported. A laser beam may be passed through the first housing component 102 to the underlying joint geometry or geometries below. The second housing component 104 may absorb a portion (e.g., a majority) of the energy, which may cause the material of the second housing component 104 (along the laser-welded joint 106, for example) to melt. The pressure and phase change of the material may cause the first housing component 102 to join to the second housing component. In some examples, because the print cartridge 100 is under pressure, the print cartridge 100 may collapse slightly, which may cause the material along the laser-welded joint 106 to widen. In some examples, an edge or edges of the laser-welded joint 106 may include pressed-out material. For instance, the laser welding and pressure may cause molten material to flow and/or to be pressed out along the laser-welded joint 106.

Metal traces 108 may be situated in (e.g., through) the laser-welded joint 106. A metal trace is a metal conductor, wire, or path. In some examples, the metal traces 108 may extend through the laser-welded joint 106 between an inside of the print cartridge 100 and an outside of the print cartridge. For instance, the metal traces 108 may be sealed in the laser-welded joint 106 from an outside of the print cartridge 100 to an inside of the print cartridge 100. In some examples, the inside of the print cartridge 100 may contain print liquid. In some examples, the metal traces 108 may be coupled to a sensor for the interior of the print cartridge 100. In some examples, the metal traces 108 may be coupled to an electrical interface (e.g., electrical connection pad(s)) for the exterior of the print cartridge 100. The electrical interface may be utilized to communicate with a printer in some examples.

The metal traces 108 may include a material that is able to conduct electricity or electrical signals. For example, the metal traces 108 may be a metal wire or ribbon. In some examples, two (or more) metal traces 108 may be situated through (e.g., sealed in) the laser-welded joint 106.

In some examples, the metal traces 108 may be included in a film. A film is a strip or length of material. In some examples, the film may be flexible and/or may be relatively flat or have a ribbon shape. In some examples, the film may include a protective layer or layers. A protective layer is a layer of material that protects a metal trace or traces.

In some examples, the metal traces 108 may be covered by a protective layer or layers. In some examples, the protective layer(s) may be polyimide (PI), polyethylene naphthalate (PEN), and/or polyethylene terephthalate (PET), etc. In some examples, the film and/or protective layer(s) may isolate and/or protect the metal traces 108 from the print liquid. For example, a protective layer or layers may be utilized to house the electrical interconnect(s). For instance, the metal traces 108 may be embedded within (e.g., sandwiched between) protective layers. In some examples, the protective layer(s) may be flexible.

In some examples, the protective layer(s) may be transmissive. A transmissive protective layer(s) may allow welding (e.g., laser welding, ultrasonic welding, vibration welding) to be performed through the protective layer(s). For example, a transmissive protective layer may allow the transmission of a welding laser beam through the protective layer(s). For instance, the laser-welded joint 106 may be welded with a laser that passes through the film and/or protective layer that covers the metal traces 108. In some examples, the metal traces 108 may be spaced within a flexible film along the laser-welded joint 106. For instance, the metal traces 108 may be spaced to allow a welding laser to pass between the metal traces 108 and melt the joint. In some examples, the protective layer(s) may have a melting temperature (e.g., minimum melting temperature) that is greater than a melting temperature of material along the laser-welded joint 106 (e.g., joint material). In some examples, the protective layer(s) may be exposed to temperatures up to approximately 300 C to 350 C for short periods without becoming damaged. In some examples, the laser-welded joint 106 may be sealed around the protective layer(s). Using a film and/or protective layer(s) with a greater melting temperature may allow welding techniques to be performed while reducing or eliminating damage to the metal traces 108. In some examples, the protective layer(s) may be compatible with the print liquid. For example, the protective layer(s) may not significantly degrade in the presence of print liquid and/or may not negatively impact the quality of the print liquid.

The metal traces 108 may be sealed in the laser-welded joint 106. For example, the seal may be a compression seal and/or a welded seal. The seal may be a waterproof seal (e.g., a seal to contain liquid such as print liquid). For example, the sealing may prevent the print liquid from leaking from the inside of the print cartridge 100 to the outside of the print cartridge 100, while allowing the metal traces 108 (or electrical interconnect(s)) to pass through the laser-welded joint 106. In some examples, the seal may prevent air from leaking into the print cartridge 100. In some examples, the laser-welded joint 106 may be a waterproof seal around a flexible film that includes the metal traces 108.

In some examples, the seal may be formed from the material(s) of the first housing component 102 and/or the second housing component 104. For example, the metal traces 108 with the film and/or protective layer(s) may be sealed through the laser-welded joint 106 without additional sealing material(s) such as additional plastic, rubber, elastomer, thermoplastic elastomer, adhesive (e.g., pressure sensitive adhesive), component(s), and/or gasket(s). In some examples, the film and/or protective layer(s) may not bond with the joint material (e.g., the first housing component 102 and/or the second housing component 104).

In some examples, the metal traces 108 may be sealed in a passage region. A passage region is a portion of the laser-welded joint 106 and/or joint geometry where the metal traces 108 passes between the inside of the print cartridge 100 and the outside of the print cartridge 100. In some examples, the metal traces 108 may be positioned transversally to the laser-welded joint in a passage region. In some examples, the laser-welded joint 106 may include a stepped structure in the passage region. The stepped structure is a geometrical structure that includes a step or ramp. In some examples, the laser-welded joint 106 may not include a stepped structure in the passage region.

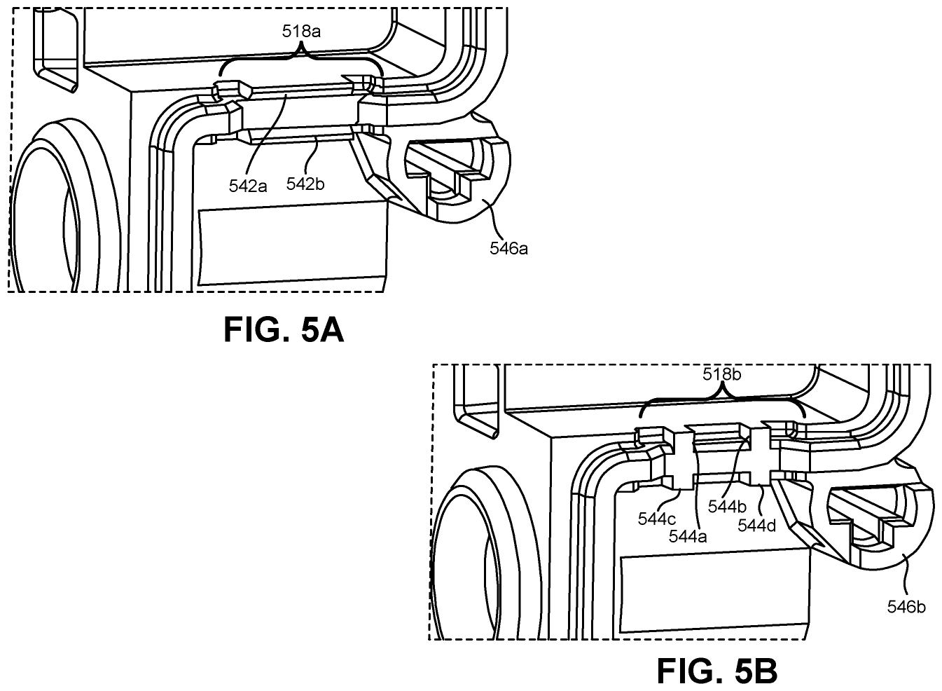

In some examples, the first housing component 102 and/or the second housing component 104 may include a flow structure or flow structures. A flow structure is a structure to control a flow of joint material (e.g., material in the laser-welded joint 106) during welding. For example, a flow structure may direct the flow of joint material and/or may help to ensure that the joint material fills a potential gap or gaps. In some examples, the flow structure may include a protruding rib or ribs along edges of the laser-welded joint 106. The protruding rib or ribs may maintain joint material in the laser-welded joint 106 during welding. For example, the protruding ribs may form a lengthwise channel along the joint or along joint geometry. The channel may hold joint material (e.g., molten joint material) along the laser-welded joint 106 during welding. In some examples, the protruding rib or ribs may compress during welding. An example of protruding ribs is given in connection with FIG. 5A.

In some examples, the joint geometry may include an extended structure or structures that extend the side(s) of the joint geometry in a passage region. For example, the extended structure(s) may provide additional joint material. The additional joint material may help to fill potential gaps in the passage region. An example of extended structures is given in connection with FIG. 5B.

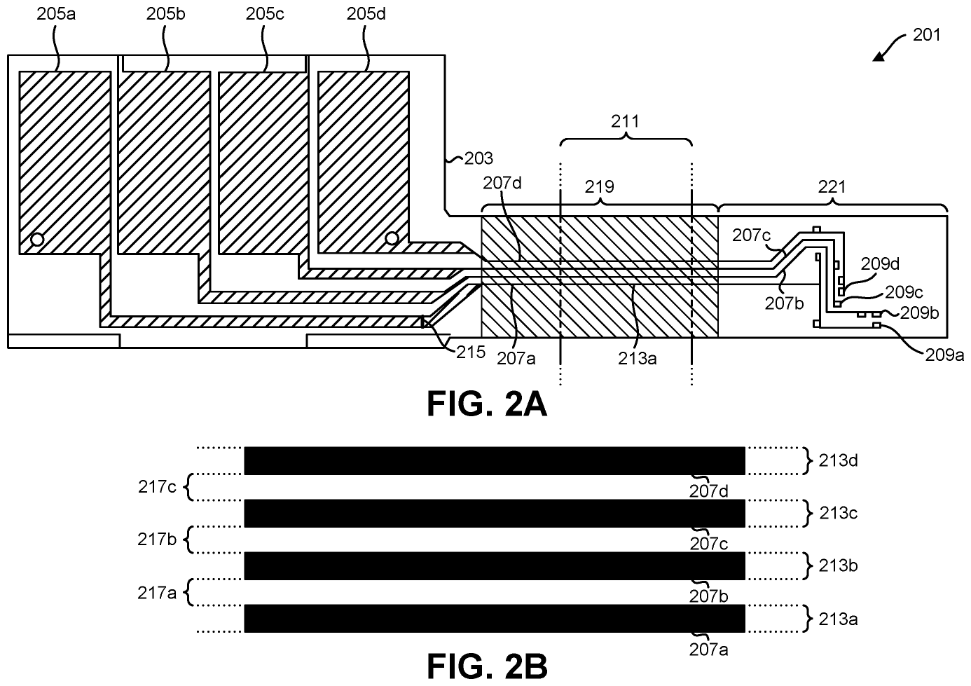

FIG. 2A is a diagram illustrating an example of an electrical connector 201. In some examples, the electrical connector 201 may be included in a print cartridge or print liquid supply unit.

The electrical connector 201 may include a protective layer 203 (e.g., substrate, bottom protective layer), protective layer 219 (e.g., top protective layer), contact pads 205a-d, metal traces 207a-d, and/or bonds 209a-d (e.g., wire bond pads). The protective layers 203, 219 may protect the metal traces 207a-d from print liquid (when a portion of the electrical connector 201 is immersed in print liquid, for instance). A contact pad is a metal pad for contacting an interfacing structure (e.g., spring connectors, pins, etc.). In some examples, the metal traces 207a-d described in relation to FIG. 2A may be an example of the metal traces 108 described in relation to FIG. 1. A bond is a metal area for bonding. Examples of a bond may include metal plates, balls, pads, etc., that may be utilized to connect to (e.g., bond to, fuse to, join with, etc.) a wire or other connector. For example, the bonds 209a-d may be a wire bond pads. Additional wire bond pads are illustrated in FIG. 2, which may be at an end of a metal trace or between ends of a metal trace. In some examples, an end portion 221 of the electrical connector 201 may be encapsulated. For instance, portions of the metal traces 207a-d and the bonds 209a-d may be encapsulated in a material for protection from print liquid. In some examples, each of the metal traces 207a-d may include copper, nickel, palladium, gold, and/or other metal(s) (e.g., a copper layer, a nickel layer on the copper layer, and a gold layer on the nickel layer). In some examples, the metal traces 207a-d may have a thickness between 8 and 70 microns (e.g., 20 microns, 35 microns, etc.). In some examples, a protective layer may have a thickness between 10 microns and 200 microns. In some examples, the thickness of the protective layers 203, 219 with the metal trace 207a-d thickness may range between 28 microns to 470 microns.

In some examples, a first metal trace 207a may be a serial data line, a second metal trace 207b may be a clock line, a third metal trace 207c may be a power line, and/or a fourth metal trace 207d may be a ground line. In some examples, the serial data line, clock line, power line, and/or ground line may be arranged in a different order and/or may correspond to different metal traces (e.g., contact pads and/or bonds). In some examples, a serial data line is a line that carries serial data to and/or from sensor circuitry coupled to the electrical connector 201. In some examples, a clock line is a line that carries a clock signal to and/or from sensor circuitry coupled to the electrical connector 201. In some examples, a power line is a line that carries power (e.g., a voltage and/or electrical current) to and/or from sensor circuitry coupled to the electrical connector 201. In some examples, a ground line is a line that provides grounding for sensor circuitry coupled to the electrical connector 201. In some examples, the sensor circuitry may be coupled to the bonds 209a-d with metal (e.g., gold, silver, aluminum, copper, etc.) wires. In some examples, the sensor circuitry may detect a print liquid level (e.g., a level of print liquid in a print liquid supply unit, a print liquid container, a print cartridge, etc.). In some examples, the sensor circuitry may sense strain and/or pressure. It may be beneficial to provide an electrical connector 201 that enables electrical signaling and/or power to pass from the exterior of a print component to the interior of the print component.

In the example illustrated in FIG. 2A, the metal traces 207a-d are situated in a laser-welded joint 211. For example, the metal traces 207a-d are included in a film (e.g., on and/or between protective layer(s) 203, 219) that is situated in the laser-welded joint 211. The laser-welded joint 211 may be an example of the laser-welded joint 106 described in relation to FIG. 1. The laser-welded joint 211 may be a waterproof seal around the film (e.g., protective layers 203, 219) that includes the metal traces 207a-d. In some examples, the width of the protective layers 203, 219 may be 2.62 millimeters (mm) at the laser-welded joint 211. Other widths may be utilized. In some examples, a width of a metal trace at a laser-welded joint may be less than a width of a film or protective layer (at the laser-welded joint, for instance). For example, a width 213a of a first metal trace 207a at the laser-welded joint 211 is less than a width of the protective layer(s) 203, 219 at the laser-welded joint 211.

In some examples, a width of a metal trace at a laser-welded joint may be less than a width of a portion of the metal trace that is away from the laser-welded joint. For instance, a width 213a of a first metal trace 207a at the laser-welded joint 211 is less than a width 215 of a portion of the first metal trace 207a that is away from the laser-welded joint. In some examples, a metal trace or metal traces may be widened away from the laser-welded joint. For instance, metal trace width may be relatively thin at the joint to enable laser welding and may be widened away from the joint to increase robustness. For instance, a metal trace width at the joint may be 60 microns and a metal trace width away from the joint may be 300 microns (or another width that is larger than 60 microns, for example). The widening may provide better durability for mechanical interfacing in some examples. For instance, the metal traces 207a-d may be widened towards the contact pads 205a-d for increased durability, because spring connectors may exert pressure on the contact pads 205a-d. Thin metal traces by contact pads may be prone to breakage due to spring connector over-travel. In some examples, metal trace width may be widened to reduce electrical resistance.

FIG. 2B is a diagram illustrating an example of a magnified view of metal traces 207a-d. FIG. 2B illustrates examples of metal trace widths 213a-d and spacings 217a-c. In some examples, metal traces may widths and spacing to enable laser welding to occur between the metal traces. For instance, if metal traces are too wide and/or are spaced too closely, the metal traces may obstruct the welding laser from adequately melting underlying joint material. Some examples of the metal trace widths and spacing described herein may enable laser welding through an electrical connector and/or between metal traces. Metal trace width may be reduced (e.g., minimized) in the weld path for a laser-welded joint to enable laser energy transmission.

In the example of FIG. 2B, the metal trace widths 213a-d are each 60 microns (or micrometers (μm)) and the spacings 217a-c are each 60 microns. In some examples, metal trace widths may range from 20 microns to 400 microns. In some examples, spacings may be greater than or equal to 20 microns. For instance, metal trace widths may be 60 microns or 90 microns with spacings of 200 microns. In some examples, metal trace widths may be uniform or non-uniform. In some examples, spacings may be uniform or non-uniform. In some examples, a neck of the protective layers 203, 219 may be less than 70% occluded by metal traces in a width dimension.

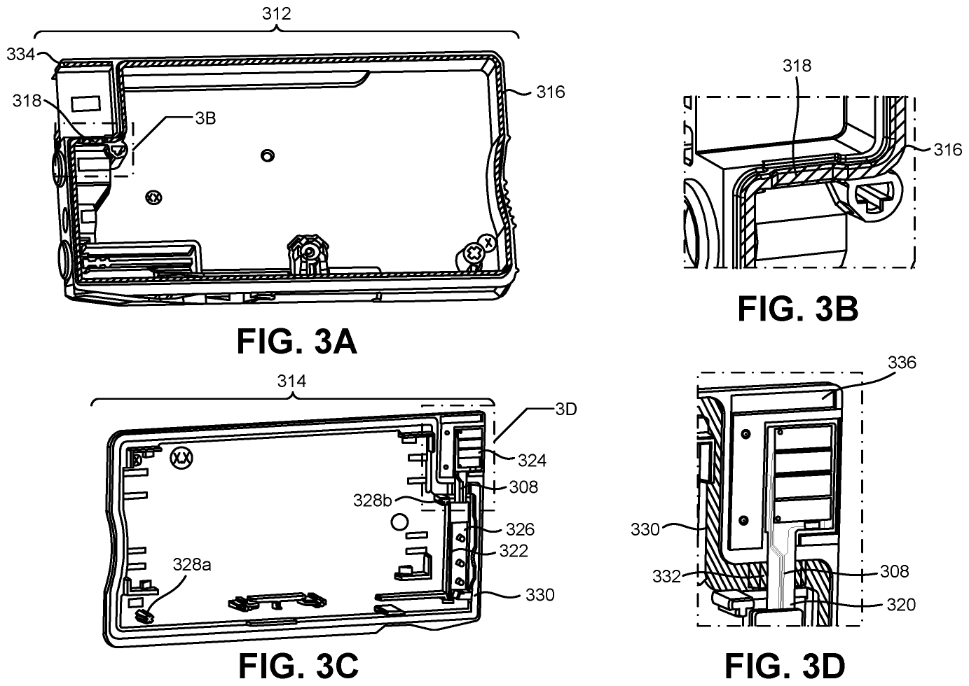

FIG. 3A is a diagram illustrating an example of a body 312. FIG. 3B illustrates an enlarged view of an example of a portion of the body 312. FIG. 3C illustrates an example of a lid 314. FIG. 3D illustrates an enlarged view of an example of a portion of the lid 314. FIGS. 3A-D will be described together. The lid 314 may be an example of the first housing component described in connection with FIG. 1. The body 312 may be an example of the second housing component 104 described in connection with FIG. 1. For instance, the body 312 may be joined with the lid 314 to form a print liquid supply unit (e.g., a print liquid container). For example, the print liquid supply unit may include a laser-welded joint between the lid 314 and the body 312 of the print liquid supply unit.

As illustrated, the body 312 includes body joint geometry 316. In some examples, joint geometry may be a kind of energy director that directs welding energy. For example, the body joint geometry 316 may direct laser welding energy to melt (e.g., partially or completely melt) the body joint geometry 316 in order to join the body 312 and the lid 314. It these examples, the body joint geometry 316 includes a raised rectangular structure with a chamfer on an edge or edges (e.g., on the exterior perimeter and/or interior perimeter). The body joint geometry 316 may provide joint material (e.g., a majority of plastic material) that melts in the joint to create a seal. For instance, the body joint geometry 316 may be laser-welded to produce a laser-welded joint between the lid 314 and the body 312 of the print liquid supply unit. The body joint geometry 316 may include a passage region 318. In some examples, the metal traces 308 may be positioned transversally to the laser-welded joint at the passage region 318. For instance, the metal traces 308 may be positioned at approximately 90 degrees (e.g., between 45 degrees and 135 degrees) relative to the joint at the passage region 318. In some examples, body joint geometry 316 includes a stepped structure in the passage region 318. For example, the stepped structure is stepped inward with two angled sections (e.g., sections at 45-degree angles) and a flat section where metal traces 308 pass through the joint. In some examples, the body 312 may include a separate welding section 334 corresponding to a counterpart recess 336 on the lid 314 for structural support.

A sensor assembly is illustrated with the lid 314. In this example, the sensor assembly includes metal traces 308, protective layers 320, electrical pads 324, sensor(s) 322, and a sensor support 326. In some examples, the metal traces 308 and protective layers 320 may form a flexible connector. In some approaches, the metal traces 308 and the sensor support 326 are mounted to the lid 314 before welding the lid 314 and body 312. In some examples, press-fit posts 328a-b may be inserted into counterpart sockets to align the lid 314 to the body 312 before welding (e.g., laser welding). Other approaches and/or structures may be utilized to align the body 312 and lid 314. For example, the two ends of the metal traces 308 may be loose on both ends and alignment (and/or holding) of the body 312, lid 314, and metal traces 308 may be accomplished with other procedures.

As illustrated in this example, lid joint geometry 330 includes a recessed track. The lid joint geometry 330 may be recessed to form a flash trap. The lid joint geometry 330 may include a raised structure 332 corresponding to the step structure of the body 312. The raised structure 332 may support the metal traces 308 and the protective layers 320 (e.g., flexible connector) during welding. The protective layers 320 (e.g., laser-transmissive protective layer(s) 320) covering the metal traces 308 may be sealed in the joint by performing welding (e.g., sealed in the laser-welded joint).

In some examples, the body 312 and lid 314 may be container shells of a print liquid container. In some examples, the sensor 322 may be a container property sensor that includes a strain sensor or pressure sensor. The sensor 322 may be connected to a container wall. For example, the sensor support 326 and/or the sensor 322 may be connected to the container wall using posts (e.g., pressure-fit posts, posts that are swaged), adhesive, and/or another technique for attachment. A container wall is a barrier or partition of a container. The body 312 and/or lid 314 may include a container wall or container walls. In some examples, the metal traces 308 may be coupled to the property sensor 322 and may be sealed through a welded joint of container shells. For instance, the print liquid supply unit may include a laser-transmissive protective layer 320 covering the metal traces 308 that is sealed in the laser-welded joint. In some examples, the property sensor 322 may include a digital liquid level sensor.

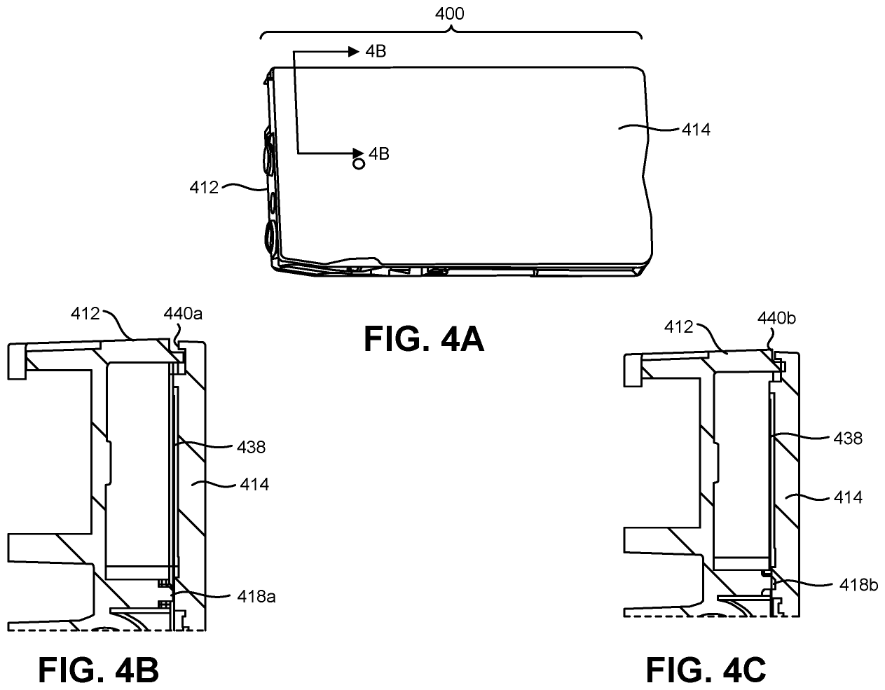

FIG. 4A is a diagram illustrating an example of a print liquid supply unit 400. FIG. 4B illustrates an example of a cross section of the print liquid supply unit 400 before welding. FIG. 4C illustrates an example of the cross section of the print liquid supply unit 400 after welding. The print liquid supply unit 400 may be an example of the print cartridge 100 described in connection with FIG. 1 or the print liquid supply unit described in connection with FIG. 3. The print liquid supply unit 400 includes a lid 414 and a body 412. The cross section illustrated in FIG. 4B is aligned with a middle of the passage region where an electrical connector 438 is located.

As described above, FIG. 4B illustrates a cross-section prior to welding. In FIG. 4B, the lid 414 is placed on the body 412. A gap 440a exists between the lid 414 and the body 412 to accommodate a collapse during welding. Before welding, the electrical connector 438 (e.g., metal traces, film, and/or protective layer(s)) may be positioned through the passage region 418a.

As illustrated in FIG. 4C, the lid 414 is in a collapsed position after welding (e.g., the gap 440b between the body 412 and lid 414 is reduced). Joint material in the passage region 418b may melt to seal the joint. In some examples, the lid 414 may collapse in a 0.3-0.5 millimeter (mm) range during welding. In some examples, a welding laser (e.g., a near infrared (IR) laser) may have a nominal wavelength of 980 nanometers (nm) (e.g., in a 900-1080 nm range). In some examples, the lid 414 has a transmissivity in a 30-60% range and the body 412 may be doped such that the body 412 (e.g., joint geometry) absorbs a large proportion of laser energy (e.g., 80%, 90%, 100%, etc.). In some examples, the lid 414 may accordingly heat up when exposed to the welding laser, though a majority of the molten material used to form the weld may come from the body 412. For example, body joint geometry in the passage region 418b may melt to seal the electrical connector 438 in the joint. While some examples for collapse distance, laser wavelength, transmissivity rate, and absorption rate are given, other values may be utilized in other examples.

FIG. 5A is a diagram illustrating an enlarged view of an example of a passage region 518a. The passage region 518a may be implemented in some of the print liquid supply units described herein. For example, the passage region 518a may include a portion of body joint geometry where an electrical interconnect or interconnects (e.g., an electrical connector with a protective layer or layers) may be situated (e.g., sealed). FIG. 5A includes an example of a flow structure to control a flow of joint material during welding.

In this example, the flow structure includes protruding ribs 542a-b. In this example, the protruding ribs 542a-b are located along edges of the joint. In other examples, protruding ribs may be located differently (e.g., may be in-set from the edge(s) of the joint. The protruding ribs 542a-b may maintain joint material in the joint during welding. For example, the protruding ribs 542a-b have a wedge shape and are located above and below the energy director in the passage region 518a. The wedge shape may reduce the amount of energy absorbed by the protruding ribs 542a-b during welding. Wedges or other shapes may be utilized. In some examples, the protruding ribs 542a-b compress during welding. For example, the protruding ribs 542a-b may act as crush ribs to trap joint material (e.g., keep joint material in the joint) and conform around the electrical interconnect(s) (e.g., protective layer(s) and/or electrical connector). A flow structure (e.g., protruding ribs) may be beneficial to provide increased robustness for the seal in a passage region.

In some examples, supporting material 546a (e.g., an energy director) may be utilized near a corner or corners to strengthen the joint at a corner or corners. For example, the supporting material 546a may be located at a socket to add structural robustness to the inside corner of the weld. This may improve strength when the print liquid supply unit is pressurized. In some examples, the supporting material 546a may be utilized to add strength and/or may not be utilized for sealing.

FIG. 5B is a diagram illustrating an enlarged view of an example of a passage region 518b. The passage region 518b may be implemented in the some of the print liquid supply units described herein. For example, the passage region 518b may include a portion of body joint geometry where an electrical interconnect or interconnects (e.g., an electrical connector with a protective layer or layers) may be situated (e.g., sealed). FIG. 5B includes an example of extended structures 544a-d that extend the sides of a joint geometry in a passage region 518b. In this example, the extended structures 544a-d form an “H” shape. Other shapes may be utilized in other examples.

In this example, the flow structure includes extended structures 544a-d. In this example, the extended structures 544a-d are rectangular energy directors to provide more joint material to form a seal along the edges of the electrical interconnect(s) (e.g., electrical connector). In some examples, extended structure(s) may provide more joint material in a width dimension of the joint geometry (in addition to along a length dimension of the joint geometry. For example, the extended structures may extend in a transverse direction across the joint geometry and/or weld path.

In some examples, supporting material 546b (e.g., an energy director) may be utilized near a corner or corners to strengthen the joint at a corner or corners. For example, the supporting material 546b may be located at a socket to add structural robustness to the inside corner of the weld.

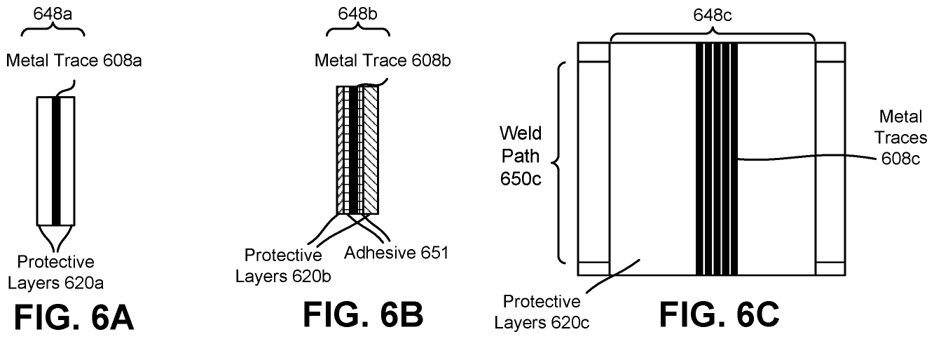

FIG. 6A is a diagram illustrating a side view of an example of a metal trace or metal traces 608a and protective layers 620a. In some examples, the thickness of the protective layers 620a and the metal trace(s) 608a may range between 0.05 millimeters (mm) and 1 mm. In some examples, a combination of metal trace(s) and protective layer(s) may be referred to as an electrical connector. For instance, FIG. 6A illustrates an example of an electrical connector 648a that includes metal trace(s) 608a and protective layers 620a. In some examples, the electrical connector 648a may include 1 to n number of metal traces 608a sandwiched between protective layers 620a. In some examples, the metal trace(s) 608a may be sandwiched between two protective layers 620a that are bonded or cast together to creating a seal between the protective layers 620a without adhesive.

In some examples, the protective layers 620a may be transmissive and welding (e.g., a welding laser) may pass over and/or through the electrical connector 648a (e.g., through the protective layers 620a). In some examples, the protective layer(s) may have a transmissivity in a range between 5% and 95%. The transmissivity may allow body joint geometry material behind the electrical connector 648a to melt. During welding, the transmissivity may allow the lid to heat up and the body material to melt and flow in multiple (e.g., five) directions around the electrical connector, making a compression seal around the flex protective material that is watertight. In some examples, the seal may be a compression seal because the plastic may conform around the electrical connector, but may not bond to the protective layer(s).

In some examples, materials used to encapsulate the metal trace(s) 608a may have a melting temperature that is greater than a melting temperature of body and/or lid material to avoid damaging the materials. In some examples, the materials used to encapsulate may be robust enough to withstand liquid attack and may be inert to the print liquid. In some examples, the electrical connector 648a may be flexible.

FIG. 6B is a diagram illustrating a side view of an example of a metal trace or metal traces 608b and protective layers 620b. In some examples, the thickness of the protective layers 620b and the metal trace(s) 608b may range between 0.05 mm and 1 mm. For instance, FIG. 6B illustrates an example of an electrical connector 648b that includes metal trace(s) 608b and protective layers 620b. In some examples, the electrical connector 648b may include 1 to n number of metal traces 608b sandwiched between protective layers 620b that are bonded and sealed together using adhesive 650. In some examples, the electrical connector 648b may be flexible. In some examples, the protective layers 620b and/or the adhesive 650 layers may be transmissive. In some examples, the protective layers 620b may not bond with joint material.

FIG. 6C is a diagram illustrating a front view of an example of flexible electrical connector 648c including metal traces 608c and protective layers 620c. In the example of FIG. 6C, the electrical connector 648c is situated in a weld path 650c. The weld path 650c is a path along which welding is performed. For example, a weld path 650c may be located in a joint. In some examples, the electrical connector 648c may include 1 to n number of metal traces 608c. Joint material in the weld path 650c may melt and flow in several directions (e.g., 5 directions) to create a compression joint around the protective layers 620c that creates a seal.

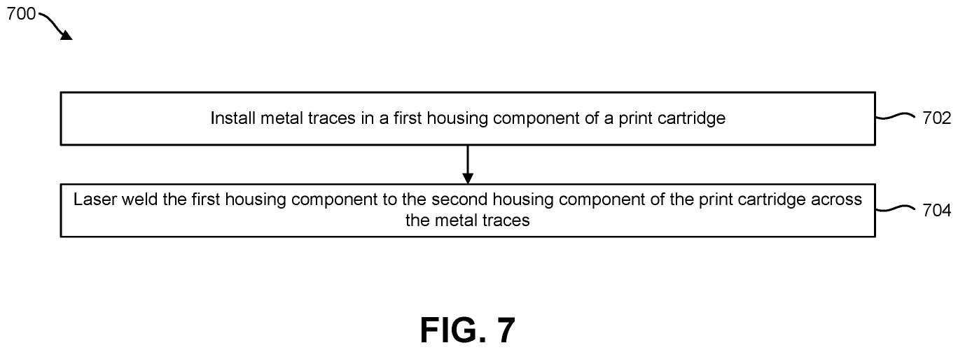

FIG. 7 is a flow diagram illustrating one example of a method 700 for manufacturing a print cartridge. In some examples, the method 700 may be performed by an assembly machine or machines. The method 700 may include installing 702 metal traces in a first housing component of a print cartridge. For example, the metal traces (in a film and/or protective layers, for instance) may be placed on a first housing component (e.g., lid).

In some examples, the metal traces may be coupled to a digital liquid level sensor and/or a strain sensor or pressure sensor. In some approaches, the digital liquid level sensor may include an array of heaters and temperature sensors. Measurements from the digital liquid level sensor may but utilized to determine a print liquid level. For example, the digital print liquid level sensor may activate the array of heaters and measure the temperature at different levels. Lesser temperatures may correspond to heaters and temperature sensors that are below the print liquid level. Greater temperatures may correspond to heaters and temperature sensors that are above the print liquid level. The measured temperatures may indicate the level of the print liquid due to the different specific heats of print liquid and air.

In some examples, a strain sensor or a pressure sensor may be utilized to detect a condition (e.g., pressure and/or structural condition) in the print liquid container. For instance, the print liquid container may include a pressure chamber in some examples. The pressure chamber is a device that changes structure based on pressure. The pressure chamber may be expandable and collapsible. An example of a pressure chamber is a bag. In some examples, the pressure chamber may be utilized to regulate pressure (e.g., to avoid over-pressurization and/or under-pressurization due to altitude and/or temperature variations) inside of the print liquid container. In some examples, the pressure chamber may be expanded (e.g., inflated) in order to purge print liquid from a print head for servicing. In some examples, the strain sensor may be utilized to detect structural deflection of the print liquid container due to expansion of the pressure chamber. In some examples, the pressure sensor may be utilized to detect a pressure change in the print liquid container due to the expansion of the pressure chamber.

The method 700 may also include laser welding 704 the first housing component to a second housing component of the print cartridge across the metal traces. For example, a laser welding beam may be passed across the metal traces and/or between the metal traces. In some examples, the laser welding beam may be transmitted through the first housing component and/or a protective layer or layers. The laser welding may seal the metal traces in a joint between the first housing component and the second housing component. In some examples, the first housing component and/or the second housing component include a thermoplastic material.

Some examples of the techniques described herein may be beneficial. For example, some of the approaches and/or structures for passing a metal traces through a joint or through a container wall may be compatible with mass production approaches. In some examples, laser welding may be utilized, which may be cost effective, space efficient, and/or may not utilize additional joint materials. Sealing around the flexible electrical connection is accomplished & optimized by simply minimizing the number of traces in the weld joint region, their width, thickness, spacing and the overall width of the protective layers. Some examples of the techniques described herein may provide protective layer materials and thicknesses that are compatible with high volume flexible electrical connection fabrication techniques. Some examples of the techniques described herein may provide increased metal trace thicknesses and/or widths for voltage and ground traces such that electrical resistance from contact pads to a print liquid level sensor is reduced (e.g., minimized) for proper function at a range of operating temperature levels. For instance, to reduce (e.g., minimize) electrical resistance while providing narrow traces in the laser weld path, the metal traces may be widened in other areas of the electrical connection. These constraints may be met along with meeting flexible electrical connection fabrication constraints and print liquid reliability concerns.

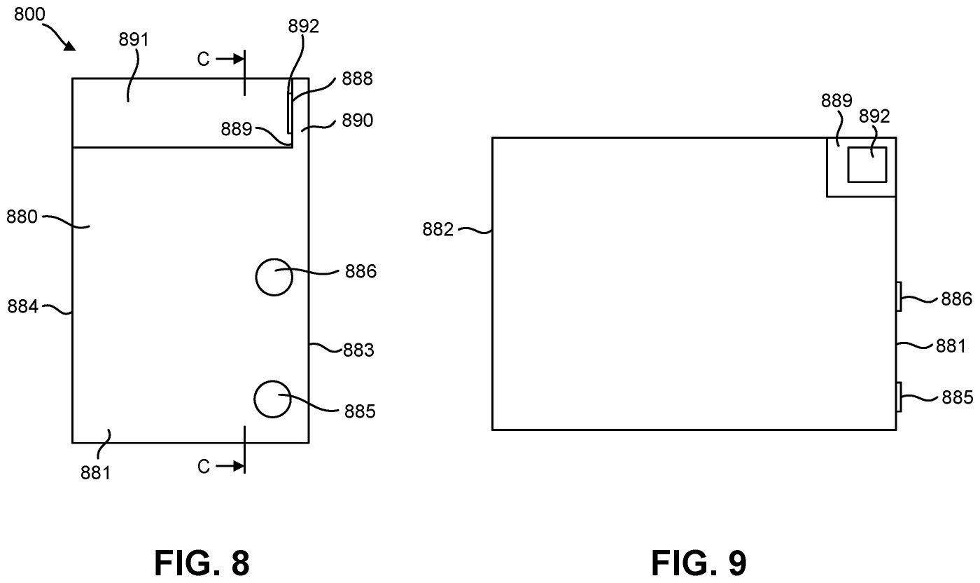

FIG. 8 shows an example print cartridge 800. In some examples, the print cartridge 800 may be an example of the print cartridge 100 described in connection with FIG. 1 and/or an example of the print liquid supply unit(s) described herein. In some examples, the print cartridge housing components 102, 104 may be implemented with the print cartridge 800. More particularly, FIG. 8 shows an elevation view of the example cartridge 800. The cartridge 800 has a housing 880 which encloses an internal volume in which the print liquid, such as ink or agent, can be stored. The internal volume of the example cartridges described herein may be between approximately 10 milliliters to approximately 50 or approximately 100 milliliters. The housing 880 has a front end 881, a rear end 882, and first and second sides 883, 884 extending from the front end to the rear end. The front end 881 and the rear end 882 can be seen also in FIG. 9, which is a cross-sectional view through the line C-C of the example print cartridge of FIG. 8. The housing 880 may comprise two relatively hard plastic shells which directly contain the print liquid therebetween. In the example, the height of the housing is greater than the width of the housing. Similarly, the height of the internal volume is greater than the width of the internal volume. The height of the internal volume may be defined by the height of the first and second sides and the width of the internal volume may be defined by the distance between the first and second sides.

The front end 881 may have a print liquid outlet 885 through which the print liquid can be supplied to a printer, for example by insertion of a fluid pen of the printer therein. The print liquid outlet 885 may be provided closer to the bottom than to the top of the front end 881.

A gas inlet 886 may be provided on the front end 881 also, to enable gas such as air to be supplied to the cartridge, for example, by insertion of a fluid pen of the printer therein. The gas inlet 886 may be positioned above the print liquid outlet 885.

A first wall 888 having an internal side 889 and an external side 890 may be provided to delimit a recess 891. In the example shown, the recess 891 extends from the first wall 888 across the entire width of the front end 881. The first wall 888 thus overhangs a notched corner of the housing. The external side 890 of the first wall 888 may be part of the first side 883 of the housing 880. Electrical connection pads 892 are exposed on the internal side of the first wall, as shown also in FIG. 9. The electrical connection pads 892 are indicated by a single block in FIGS. 8 and 9. In one example, there are three electrical connection pads, although fewer or more connection pads may be provided. The electrical connection pads may be arranged in a top to bottom direction. The electrical connection pads enable electrical signals to be communicated between electrical circuitry of the cartridge and electrical circuitry of the printer, for example in accordance with an inter-integrated circuit (I2C) data communication protocol. Hence, the connection pads may form an I2C data interface. Providing the electrical connection pads 892 to the first wall 888 allows for easy mounting of the electrical connection pads 892 on the cartridge. Being positioned on the internal side 889, the electrical connection pads 892 are protected from damage when shipping and handling the cartridge. The recess 891 can receive an electrical connector of a printer to establish an electrical connection between the electrical connection pads 892 and the electrical connector.

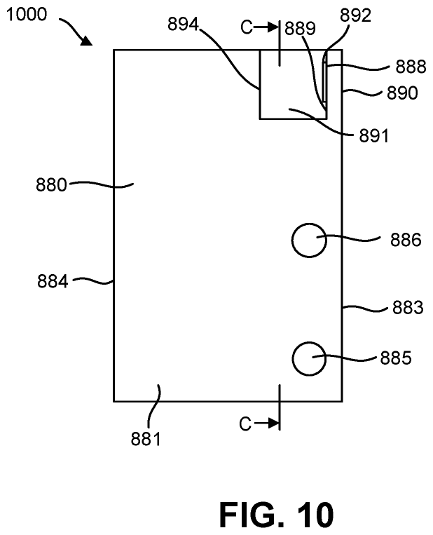

FIG. 10 shows another example print cartridge 1000. In particular, FIG. 10 shows an elevation view of the cartridge 1000. The example cartridge of FIG. 10 is similar to that of FIG. 8. In the example of FIG. 10, the recess 891 does not extend across the entire width of the front end 881. The recess 891 is delimited by a second wall 894. The recess 891 between the first wall 888 and the second wall 894 may receive an electrical connector of a printer therein to contact the electrical connection pads 892.

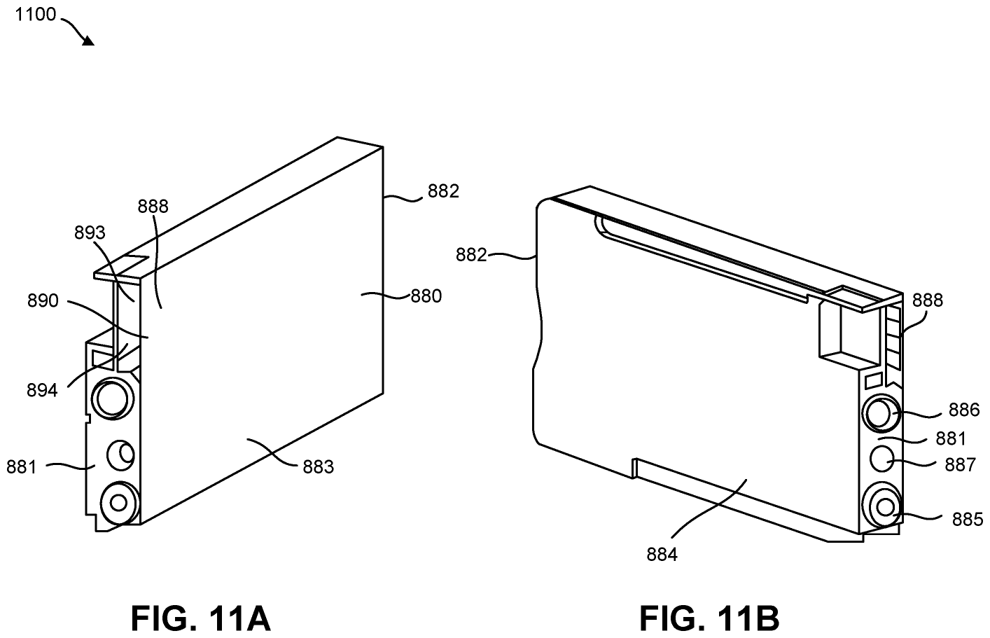

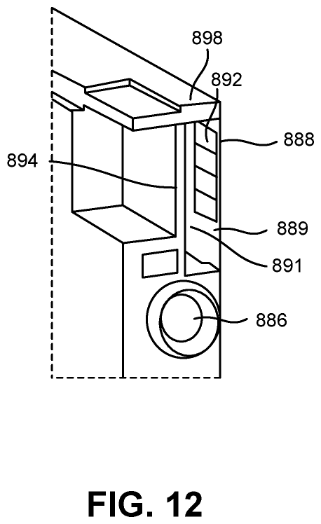

FIGS. 11A and 11B are perspective views of another example print cartridge 1100. FIG. 12 is a magnified view of part of the example cartridge 1100. The same reference numerals are used for like parts. The cartridge 1100 has a housing 880 which encloses an internal volume in which the print liquid, such as ink or agent, can be stored. The housing 880 has a front end 881, a rear end 882, and first and second sides 883, 884 extending from the front end to the rear end. A print liquid outlet 885 and a gas inlet 886 may be provided on the front end. The print liquid outlet 885 may be provided closer to the bottom than to the top of the front end 881. The gas inlet 886 may be positioned above the print liquid outlet 885. The front end may also have a print liquid inlet 887 to enable the cartridge to be filled or re-filled with print liquid.

In the example of FIGS. 11A, 11B, and 12, there may be provided a datum surface 893 across the recess from the internal side 889 of the first wall 888. A rib 898 may support the first wall 888. In the example shown, the datum surface is a side of a second wall 894 facing towards the recess 891. The datum surface 893 helps ensure smooth installation and removal of the print cartridge to and from a printer.

In some examples, the print cartridge 1100 may include a conductor or conductors that are situated through a joint of the print cartridge 1100. The conductor(s) may be examples of the metal trace(s) described herein. For example, a first conductor may be a serial data line and/or a second conductor may be a clock line. In some examples, a third conductor may be a power line and/or a fourth conductor may be a ground line. In some examples, the conductor or conductors may be coupled to the electrical connection pad or pads 892. The electrical connection pad(s) 892 may be situated in the recess 891.

In some examples, the electrical connection pad(s) 892 and the conductor(s) may be supported by a housing component. For example, the electrical connection pad(s) and the conductor(s) may be supported by the first housing component 102 (e.g., lid) described herein. For instance, the electrical connection pad(s) and the conductor(s) may be supported by the first wall 888, which may be a first wall 888 of a first housing component. In some examples, the print cartridge 1100 includes a sensor or sensors. In some examples, the sensor(s) may be supported by the first housing component and/or the first wall 888.

In some examples, the print cartridge 1100 may include a print liquid interface or interfaces. A print liquid interface is an interface for the passage of print liquid. Examples of a print liquid interface may include the print liquid outlet 885 and the print liquid inlet 887, which may be included in the front end 881 of the print cartridge.

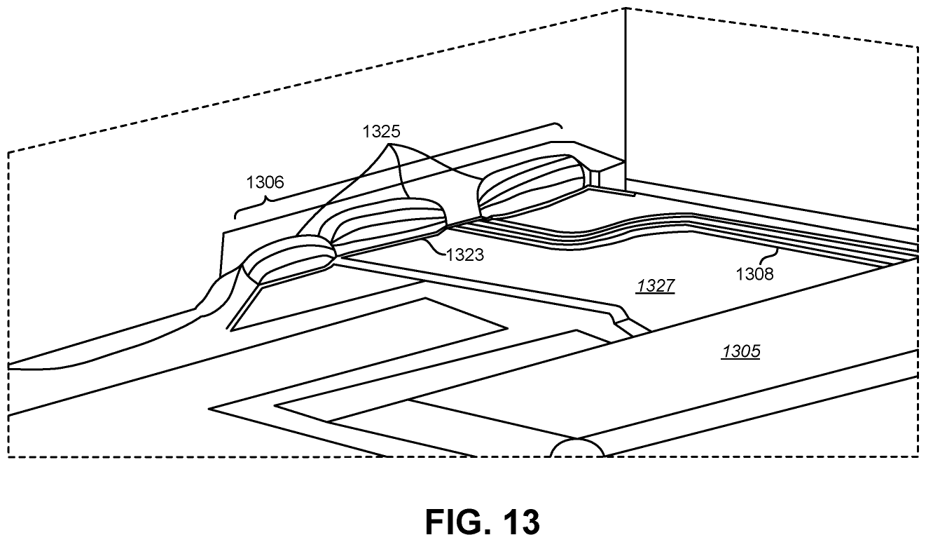

FIG. 13 is a perspective view of an example of a laser-welded joint 1306 of a print cartridge. For example, FIG. 13 illustrates metal traces 1308 in protective layers 1327, where the metal traces 1308 and the protective layers 1327 are situated in (e.g., through) the laser-welded joint 1306. An example of a contact pad 1305 is also shown. As illustrated in FIG. 13, an edge 1323 of the laser-welded joint 1306 includes pressed-out material 1325. The pressed-out material 1325 may be material that was pressed out from the laser-welded joint 1306 during manufacturing.

1. A print cartridge, comprising:
a laser-welded joint; and
metal traces situated in the laser-welded joint.

2. The print cartridge of claim 1, wherein the laser-welded joint is between opposite housing components including a first housing component and a second housing component, wherein the first housing component and the second housing component have an overlapping melting temperature range.

3. The print cartridge of claim 1, further comprising a protective layer for the metal traces, wherein the protective layer has a melting temperature that is greater than a melting temperature of material along the laser-welded joint, and wherein the laser-welded joint is sealed around the protective layer.

4. The print cartridge of claim 3, wherein the protective layer is flexible.

5. The print cartridge of claim 1, wherein at least a portion of the print cartridge is designed to melt using a welding laser.

6. The print cartridge of claim 1, wherein at least a portion of a first housing component of the print cartridge near the laser-welded joint is at least partly laser-transmissive or at least partly transparent.

7. The print cartridge of claim 1, wherein an edge of the laser-welded joint comprises pressed-out material.

8. The print cartridge of claim 1, wherein the metal traces extend through the laser-welded joint between an inside of the print cartridge and an outside of the print cartridge.

9. The print cartridge of claim 1, wherein a width of a first metal trace at the laser-welded joint is less than a width of a protective layer.

10. The print cartridge of claim 1, wherein the metal traces are spaced within a flexible film along the laser-welded joint.

11. The print cartridge of claim 1, wherein a width of a first metal trace at the laser-welded joint is less than a width of a portion of the first metal trace that is away from the laser-welded joint.

12. A print liquid supply unit, comprising:
a laser-welded joint between a lid and a body of the print liquid supply unit; and
a laser-transmissive protective layer covering metal traces sealed in the laser-welded joint.

13. The print liquid supply unit of claim 12, wherein the metal traces are positioned transversally to the laser-welded joint at a passage region.

14. A method, comprising:
installing metal traces in a first housing component of a print cartridge; and
laser welding the first housing component to a second housing component of the print cartridge across the metal traces.

15. The method of claim 14, wherein the laser welding seals the metal traces in a joint between the first housing component and the second housing component.
